(19) United States
(12) Patent Application Publication
(10) Pub. No.: US 2013/0326555 A1
(43) Pub. Date: Dec. 5, 2013

(54) USER PREFERENCES FOR CONTENT

(71) Applicant: Michael J. McMahon, Dublin (IE)

(72) Inventor: Michael J. McMahon, Dublin (IE)

(73) Assignee: MICROSOFT CORPORATION, Redmond, WA (US)

(21) Appl. No.: 13/488,107

(22) Filed: Jun. 4, 2012

(51) Int. Cl. H04N 21/472

(52) U.S. Cl. 725/38

(57) ABSTRACT

User preference techniques are described. In one or more implementations, a physical presence of a plurality of users is identified by a computing device from images captured using one or more cameras. A group is recognized by the computing device that includes the identified plurality of users. A set of user preferences are located by the computing device based on the recognition of the group, the user preferences generated based on content consumption by the plurality of users when physically together.

### BACKGROUND

The variety of content that is made available to a single user is ever expanding. For example, conventional television programming and radio has expanded to include video-on-demand, content that is made available for streaming via the Internet (e.g., streaming videos and music services), content downloading services, and so on.

Consequently, a single, couple or a group of modern users may be overwhelmed by the variety of content choices regarding both types of content and even the amount of content that is made available for the various types. For example, a group of users may have access to hundreds of television programs at any given point in time and therefore may find it difficult to locate a particular television program that may be of interest to that particular group of users.

### SUMMARY

User preference techniques are described. In one or more implementations, a physical presence of a plurality of users is identified by a computing device from images captured using one or more cameras. A group is recognized by the computing device that includes the identified plurality of users. A set of user preferences are located by the computing device based on the recognition of the group, the user preferences generated based on content consumption by the plurality of users when physically together.

In one or more implementations, a first set of user preferences is used by a computing device to recommend content to a first user based on identification of a physical presence of the first user. An addition of a physical presence of a second user is identified by the computing device along with the physical presence of the first user. Responsive of the identification of the second user, a second set of user preferences that correspond to the second user along with the first set of user preferences are used by the computing device to recommend content to the first and second users in which the first set of user preferences is ranked higher than the second set of user preferences in generating the recommendation.

In one or more implementations, a computing device includes one or more cameras, a display device, and one or more modules implemented at least partially in hardware. The one or more modules are configured to receive images from the one or more cameras, identify a group of users that are physically present from the images, locate user preferences for the group of users, the user preferences formed solely based on content consumption by the group of users when together, and display one or more recommendations for content, on the display device, that is currently available via a broadcast based on the located user preferences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ user preference techniques described herein.

FIG. 2 depicts an example implementation in which a ranking of user preferences is leveraged to generate recommendations for content.

FIG. 3 depicts an example implementation in which a set of preferences is defined for a group and used to make content recommendations.

FIG. 4 is a flow diagram depicting a procedure in an example implementation in which a ranking of user preferences is leveraged to generate recommendations of content for a plurality of users.

FIG. 5 depicts an example implementation in which a notification is output to confirm whether user preferences of a detected user are to be used to generate recommendations.

FIG. 6 is a flow diagram depicting a procedure in an example implementation in which identification of a group is used to locate user preferences for the group to make content recommendations.

FIG. 7 illustrates various components of an example device that can be implemented as any type of portable and/or computer device as described with reference to FIGS. 1-6 to implement embodiments of the techniques described herein.

### DETAILED DESCRIPTION

Overview

Scheduling strategies are typically employed by content providers to improve the chances of content (e.g., television programming) attracting and retaining an audience. For example, a broadcaster of a television program may employ a schedule arranged to deliver programs to audiences when users are most likely to want to watch the programs and consequently deliver audiences to advertisers in the composition that improves the effectiveness of advertising. However, conventional techniques of arriving at schedules and other content recommendations were typically based on analyzing usage of the device used to deliver the content itself and therefore did not address individual users of that device.

User preference techniques are described. In one or more implementations, users are identified that are physically present at a computing device, such as through voice recognition, facial recognition, skeletal mapping, and so on. This identification may then be used to locate preferences relating to the users. In this way, recommendations may be based on the users themselves, and not limited to the device. This identification and subsequent recommendations may be leveraged to provide a variety of functionality.

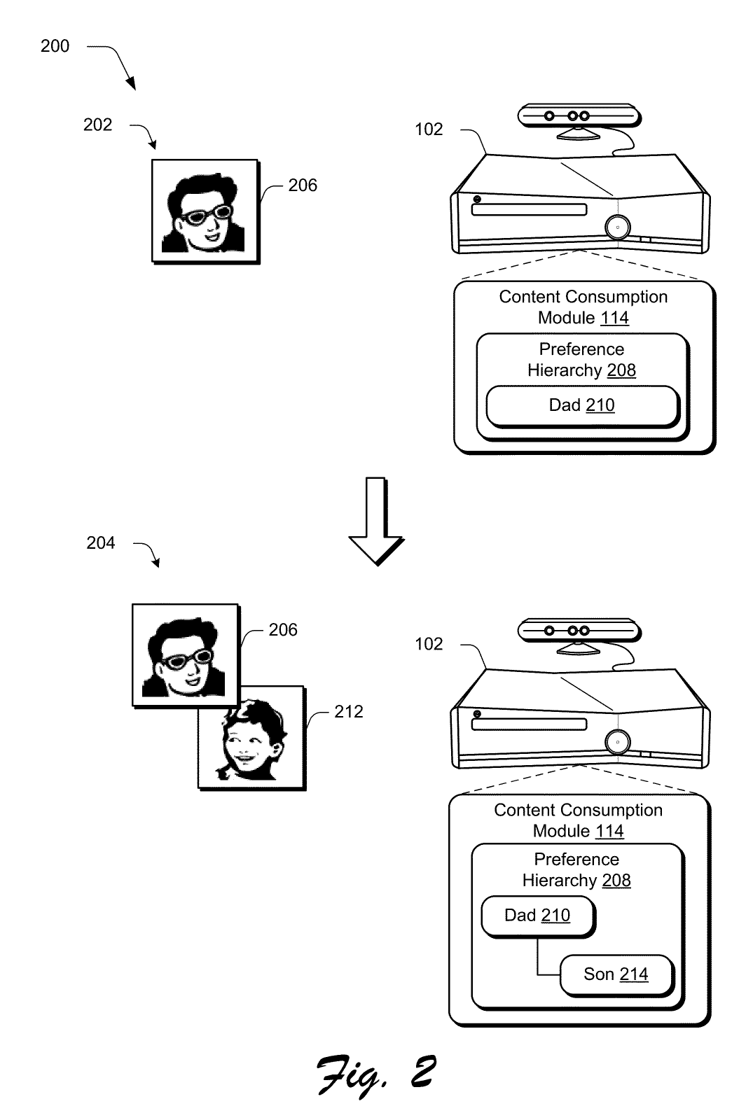

For example, a ranking technique may be employed to rank the user preferences in relation to each other. User preferences of a father, for instance, may be given greater weight that the user preferences for a son when recommending content. The ranking may also be based on a variety of other factors, such as “who was watching the TV first,” time (e.g., time of day, day of week), and so on, further discussion of which may be found beginning in relation to FIG. 2.

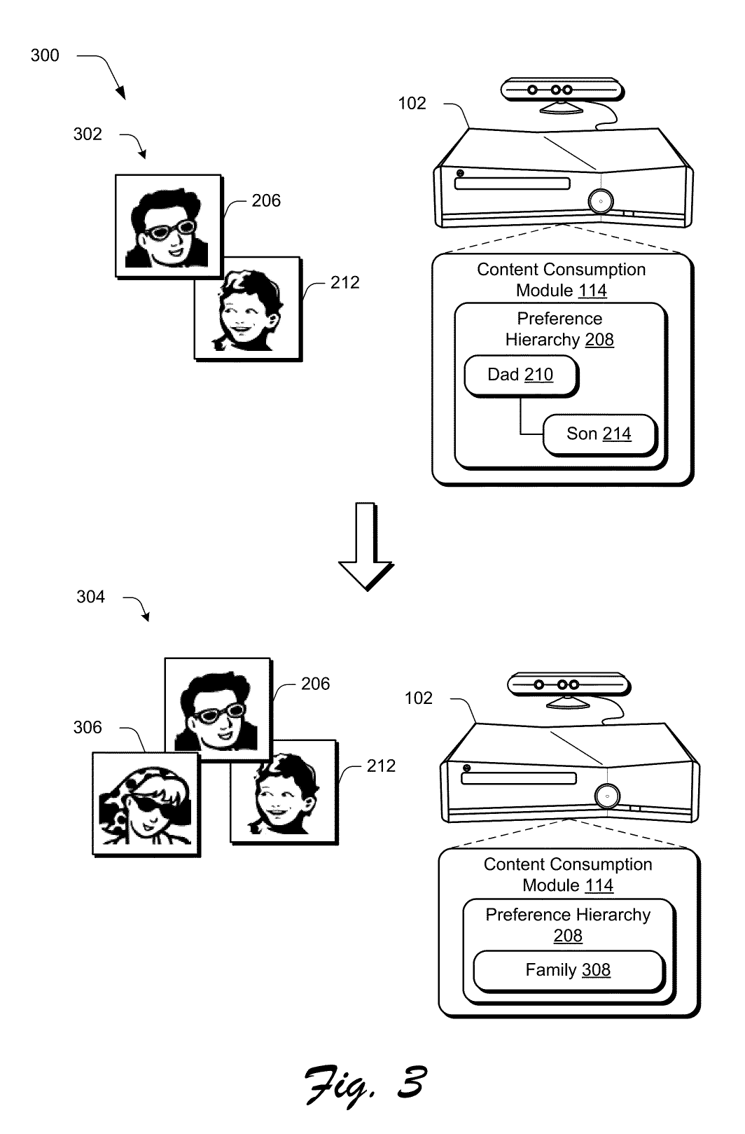

In another example, identification may be used to support group preferences. Continuing with the previous example, the viewing habits of the Dad and Son may be quite different when together as opposed to when individually consuming content. Accordingly, preferences may also be maintained based on identification of a group. Thus, recommendations may be made based on the group and not individual preferences of members of the group and thus may more accurately describe the preferences of the group, further discussion of which may be found beginning in relation to FIG. 3.

In the following discussion, an example environment is first described that is operable to employ the user preference techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

Example Environment

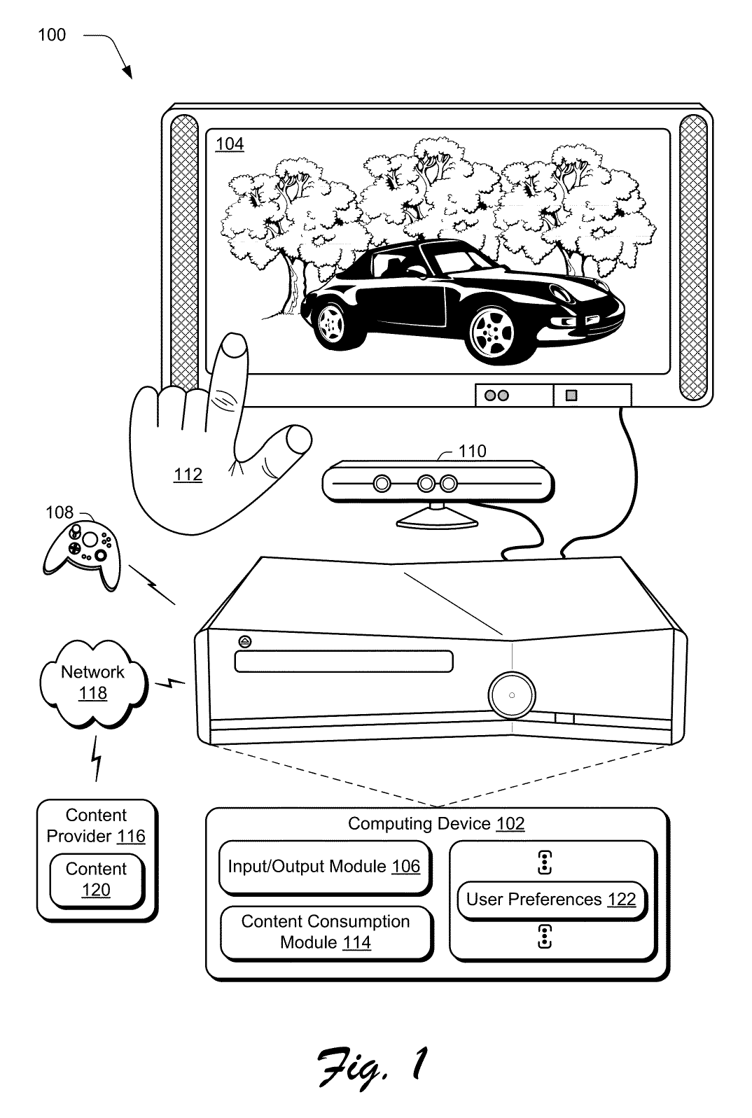

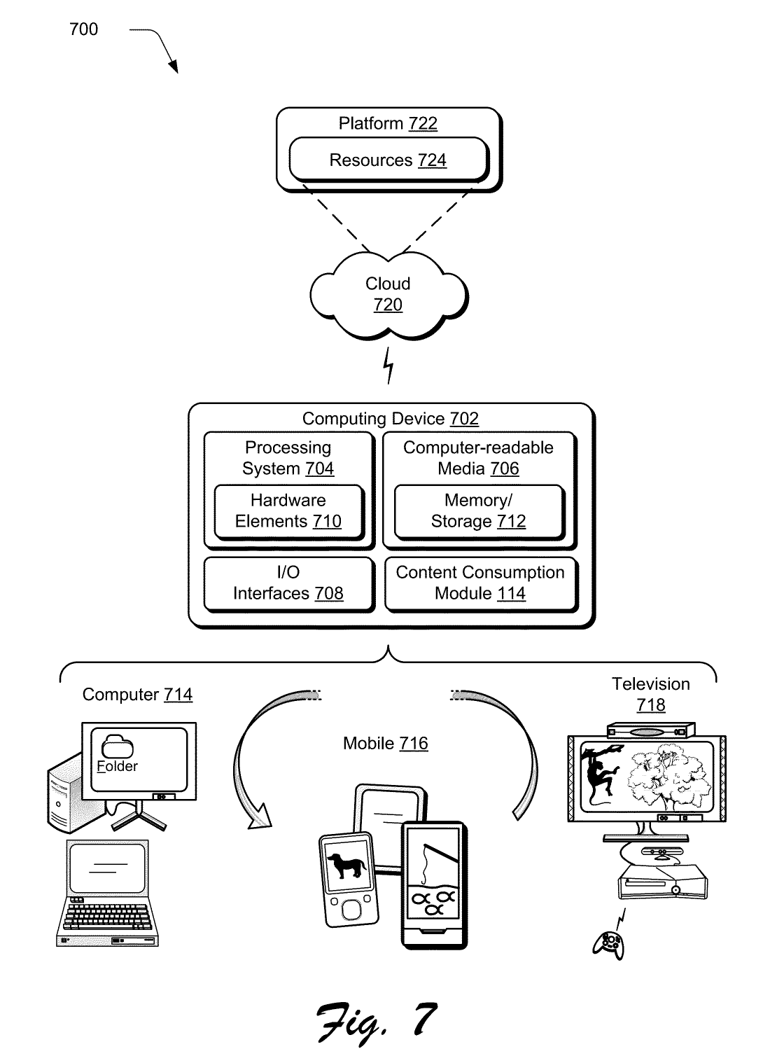

FIG. 1 is an illustration of an environment 100 in an example implementation that is operable to employ user preference techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a game console communicatively coupled to a display device 104 (e.g., a television) as illustrated, a wireless phone, a netbook, and so forth as further described in relation to FIG. 7. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input/output module 106. The input/output module 106 is representative of functionality relating to recognition of inputs and/or provision of outputs by the computing device 102. For example, the input/output module 106 may be configured to receive inputs from a keyboard, mouse, to identify gestures and cause operations to be performed that correspond to the gestures, identify users of the computing device 102 that are physically present, and so on. The inputs may be detected by the input/output module 106 in a variety of different ways.

The input/output module 106 may be configured to receive one or more inputs via touch interaction with a hardware device, such as a remote control or game controller 108 as illustrated. Touch interaction may involve pressing a button, moving a joystick, movement across a track pad, use of a touch screen of the display device 104 (e.g., detection of a finger of a user's hand or a stylus), and so on. Recognition of the touch inputs may be leveraged by the input/output module 106 to interact with a user interface output by the computing device 102, such as to interact with a game, an application, browse the internet, change one or more settings of the computing device 102, and so forth. A variety of other hardware devices are also contemplated that involve touch interaction with the device. Examples of such hardware devices include a cursor control device (e.g., a mouse), a remote control (e.g. a television remote control), a tablet computer, a mobile communication device (e.g., a wireless phone configured to control one or more operations of the computing device 102), and other devices that involve touch on the part of a user or object.

The input/output module 106 may also be configured to provide a natural user interface (NUI) that may recognize interactions that do not involve touch. For example, the computing device 102 may include a NUI input device 110. The NUI input device 110 may be configured in a variety of ways to detect inputs without having a user touch a particular device, such as to recognize audio inputs through use of a microphone. For instance, the input/output module 106 may be configured to perform voice recognition to recognize particular utterances (e.g., a spoken command) as well as to recognize a particular user that provided the utterances.

In another example, the NUI input device 110 that may be configured to recognize gestures, presented objects, images, and so on through use of a camera. The camera, for instance, may be configured to include multiple lenses so that different perspectives may be captured. The different perspectives may then be used to determine a relative distance from the NUI input device 110 and thus a change in the relative distance. The different perspectives may be leveraged by the computing device 102 as depth perception. The images may also be leveraged by the input/output module 106 to provide a variety of other functionality, such as techniques to identify particular users (e.g., through facial recognition, skeletal mapping, feature extraction, and so on as described in greater detail below), objects, and so on.

The input-output module 106, for instance, may leverage the NUI input device 110 to perform skeletal mapping along with feature extraction of particular points of a human body (e.g., 48 skeletal points) to track one or more users (e.g., four users simultaneously) to perform motion analysis that may be used to both identify the user as well as “what the user is doing.” For instance, the NUI input device 110 may capture images that are analyzed by the input/output module 106 to recognize one or more motions and/or positioning of body parts or other objects made by a user, including what body part is used to make the motion as well as which user made the motion. An example is illustrated through recognition of positioning and movement of one or more fingers of a user's hand 112 and/or movement or positioning of the user's hand 112 as a whole as well as identification of “who the hand belongs to.” Thus, the motions and/or positioning may be used to identify the user's themselves, identify gestures may by the users to initiate a corresponding operation, and so on.

A variety of different types of gestures may be recognized, such as gestures that are recognized from a single type of input as well as gestures involving multiple types of inputs, e.g., a hand gesture and voice recognition. Thus, the input/output module 106 may support a variety of different gesture techniques by recognizing and leveraging a division between inputs. In this way, the input/output module 106 may provide a natural user interface that supports a variety of user interactions that do not involve touch.

The computing device 102 is further illustrated as including a content consumption module 114 that is representative of functionality relating to consumption of content by the computing device 102. For example, the content consumption module 114 may be configured to communicate with a content provider 116 via a network 118.

The computing device 102 may then receive one or more items of content 120 from the content provider 116, such as via a broadcast, streaming, download, and so on. Content 120 may include a variety of data, such as television programming, video-on-demand (VOD) files, music, videos, and so on. A variety of other examples are also contemplated, such as by using an indirect distribution example and thus the network 118 may be representative of a variety of different types of networks via which the computing device 102 may access remote content. For instance, distribution to the computing device 102 over network 118 may be accommodated in a number of ways, including cable, radio frequency (RF), microwave, digital subscriber line (DSL), Internet, and satellite.

The content consumption module 114 may also include digital video recorder (DVR) functionality. For instance, the content consumption module 114 may include a storage device to record content 120 received via the network 118 for output to and rendering by the display device 104. The storage device may be configured in a variety of ways, such as a hard disk drive, a removable computer-readable medium (e.g., a writable digital video disc), and so on. Thus, content that is stored in the storage device of the content consumption module 114 may be copies of the content 120 that was streamed from the content provider 116, e.g., via a network provider. Additionally, content may be obtained by the computing device 102 from a variety of other sources, such as from a computer-readable storage medium that is accessed by the content consumption module 114, and so on. For example, content may be stored on a digital video disc (DVD) when the computing device 102 is configured to include DVD functionality. Thus, content consumed using the computing device 102 may originate from a variety of different locations both local to the device as well as remotely via the network 118.

The content consumption module 114 may also support techniques to generate recommendations for users that interact with the computing device 102. For example, the content consumption module 114 may leverage cameras of the NUI input device 110 through the input/output module 106 to identify users that are physically present. This may be performed in a variety of ways as previously described, such as through motion analysis, feature extraction and skeletal mapping, facial recognition, voice recognition, and so on.

Based on the identification, the content consumption module 114 may locate user preferences 122 that correspond to the identified user. The user preferences may then be used to make recommendations to the user, which may take a variety of different forms. For example, the recommendations may be used to populate a schedule. The schedule, for instance, may be populated using considerations such as a time of day, a day of a week, a season, a month of a year, and so on. The user preferences may specify genres, favorites within a genre (e.g., a particular news broadcast), and so on that in conjunction with a schedule framework may be used to generate a schedule having content that is recommended based on the user preference 122. An example of a schedule framework is shown below:

Wednesday Evening - Spring

| | |
|---|---|
| 6:00 | Local News |
| 6:30 | Local Sport |
| 7:00 | Regional News |
| 7:30 | International News |
| 8:00 | Cookery |
| 8:30 | Documentary |
| 9:00 | News Update |
| 9:30 | Current Affairs |
| 10:00 | Movie |

The content consumption module 114, for instance, may populate the framework using content that is currently available at the respective times via a broadcast, e.g., television programming, radio shows, and so forth.

Recommendations may be chosen in a variety of ways to populate the schedule framework. The framework, for instance, may be populated using considerations such as a time of day, a day of a week, a season, a month of a year, and so on. The user preferences may specify genres, favorites within a genre (e.g., a particular news broadcast), and so on that in conjunction with a schedule framework and may be used to generate a schedule having content that is recommended based on the user preference 122. Further, the user preferences may be dynamically generated by the content consumption module 114 based on identification of users and corresponding content that was consumed by the users.

Continuing with the previous example, the content consumption module 114 may recommend items of content for inclusion in the framework based on a variety of factors. Example of such factors include relevance (e.g., how relevant is the content to the day/time/individual/slot), expiration (e.g., is this a first showing or a repeat), originality (e.g., is this a rehash of existing material or truly original content), historic (e.g., if not original is it iconic or otherwise worthy of inclusion), origin (e.g., subscription based, available for free, for a fee), and so forth. An example of population of the example schedule framework is shown below:

| | | |
|---|---|---|
| 6:00 | Local News | Six-One News |
| 6:30 | Local Sport | Six-One Sport |
| 7:00 | Regional News | Channel 4 news |
| 7:30 | International News | TV5 French news |
| 8:00 | Cookery | Master Chef |
| 8:30 | Lifestyle | House builder |
| 9:00 | News Update | RTE 1 Late News |
| 9:30 | Current Affairs | Panorama |
| 10:00 | Drama | Desperate Housewives |
| 11:00 | Movie | The Lives of Others |

The content consumption module 114 may also maintain the user preferences 122, e.g., using heuristics, to reflect changes in user consumption habits as well as to accurately reflect what content is actually consumed by the user. Thus, the content consumption module 114 in this example provides a customized schedule populated by content that is recommended based on the user preferences 122. A variety of other configurations for the content recommendations are also contemplated, such as inclusion in an electronic program guide, output of notifications including the recommendations (e.g., as a pop-up menu upon identification of the user or when content becomes available), and so forth.

As previously described, various considerations may be taken into account regarding which user preferences 122 are to be used as well as how the user preferences relate to each other. This may include use of a hierarchy to rank the preferences, use of group preferences, and so on as further described beginning in relation to the following figures.

FIG. 2 depicts an example implementation 200 in which a ranking of user preferences is leveraged to generate recommendations for content. The example implementation 200 is depicted using first and second stages 202, 204. At the first stage 202, a first user “Dad” 206 is identified by the computing device 102, such as to use motion analysis of images captured using the camera of the NUI input device 110 as previously described.

In response to this identification, the content consumption module 114 initiates a preference hierarchy 208 that includes user preferences for Dad 210. The user preferences for Dad 210 may be utilized as previously described to generate recommendations.

At the second stage 204 which is at a subsequent point in time to the first stage 202, the first user Dad 206 is still identified by the content consumption module 114 as being physically present. In addition, a second user “Son” 212 is also identified as being physically present. In response, the content consumption module 114 adds user preferences for the son 214 to the preference hierarchy 208. In this way, individual preferences for both users may be used to make content recommendations.

The user preferences may be ordered in the hierarchy based on a variety of factors. For instance, user preferences of a user that was consuming content before the identification of a subsequent user may be given priority over the user preferences of the subsequent user. In this way, a user having seniority in content consumption at the computing device is also given greater weight in content recommendations made by the content consumption module 114.

In another instance, the rankings may be predefined. For example, Dad 210 may be given a higher ranking than the son 214. Further, these rankings may also be based on a variety of other factors, such as a time of day, a day of a week, a season, a month of a year, and so on. For example, Dad 210 may be ranked higher on Monday nights for Monday Night Football whereas the Son 214 may be ranked higher on Saturday mornings, e.g., to watch cartoons. Thus, in these instances individual sets of user preferences are utilized in combination to form the recommendation. Other instances are also contemplated in which a set of user preferences is maintained for a group as a whole, an example of which is described in relation to the following figure.

FIG. 3 depicts an example implementation 300 in which a set of preferences is defined for a group and used to make content recommendations. Continuing with the previous example of FIG. 2, at the first stage 302 the first user Dad 206 is identified by the content consumption module 114 as being physically present along with a second user “Son” 212. In response, the content consumption module 114 utilizes user preferences for the Dad 210 and son 214 in the preference hierarchy 208 to make content recommendations.

At the second stage 304, a third user “Mom” 306 is identified by the content consumption module 114 as being physically present along with Dad 206 and Son 212. In response, the content consumption module 114 may recognize that the three users correspond to a group that has its own set of preferences, which is illustrated as family 308 in the preference hierarchy 208 maintained by the content consumption module 114.

The set of preferences defined for the group may be configured in a variety of ways. For example, these preferences may be generated by the content consumption module 114 based on content consumption performed by the group as a whole, e.g., each of the users that may be used define the group are physically present to consume content. In this way, the set of preferences defined for the group may address content consumption preferences that may be quite different than those of the members of the group, individually.

For example, the group “family” 308 in this instance may view content that is appropriate for children but is also interesting to adults (e.g., animated movies) as opposed to content that is generally viewed by the members by themselves. For example, when consuming content alone Dad 206 may generally choose sports related content, Mom 206 may choose women related content, and the Son 212 may typically choose children's cartoons. In this way, the group preferences may address content viewing habits that may not be addressed by the preferences for the individuals alone, such as by taking an intersection of the sets of preferences for the individual users. Further discussion of the use of user preferences for recommendations regarding content may be found in relation to the following procedures.

Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-300 of FIGS. 2 and 3.

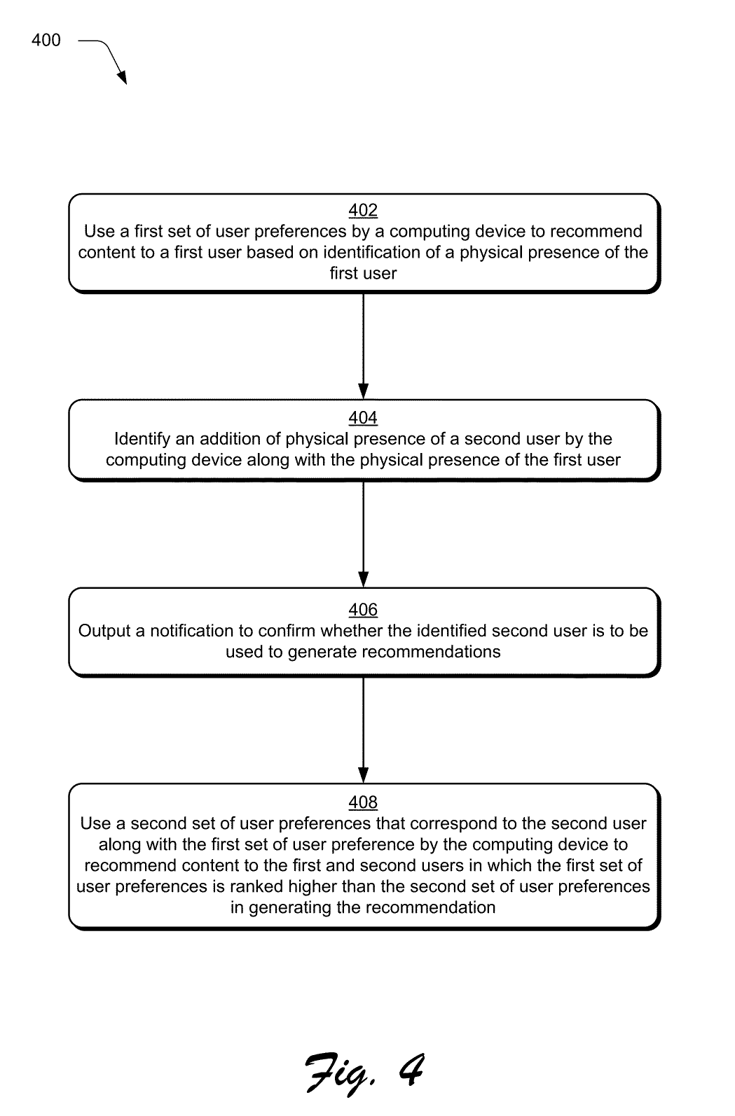

FIG. 4 depicts a procedure 400 in an example implementation in which a ranking of user preferences is leveraged to generate recommendations of content for a plurality of users. A first set of user preferences is used by a computing device to recommend content to a first user based on identification of a physical presence of the first user (block 402). As previously described, the recommendations may take a variety of forms, such as to populate a schedule framework, indicate an option in an electronic program guide, output of a notification (e.g., pop-up menu) when content of likely interest becomes available, and so on.

An addition of physical presence of a second user is identified by the computing device along with the physical presence of the first user (block 404). The second user, for instance, may enter range of the NUI input device 110 while the second user is still consuming content or otherwise still physically present. Thus, in this instance the second user has entered into a content viewing session of the first user. Thus, the first user has seniority in this example.

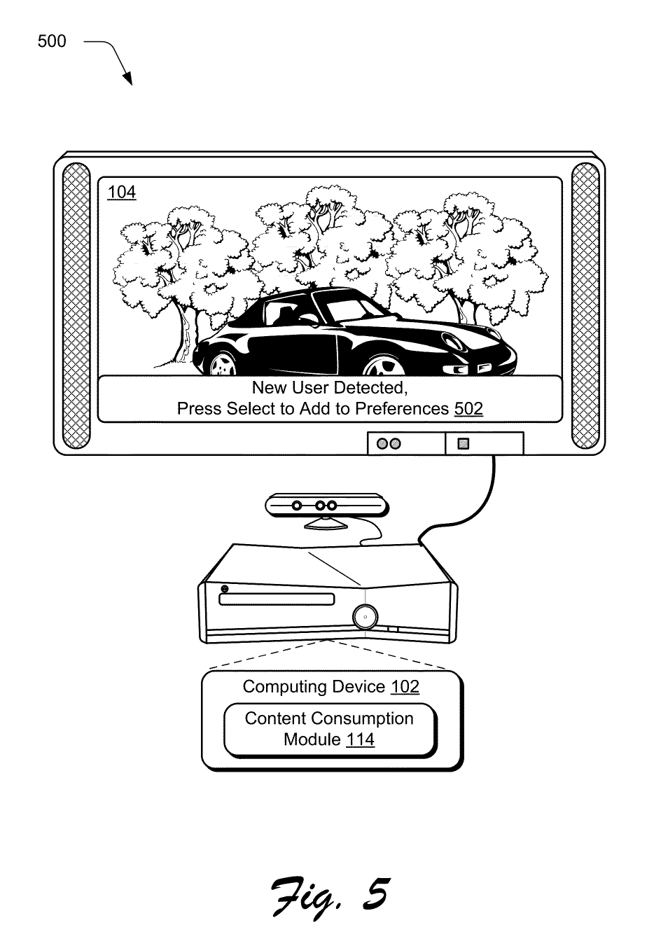

A notification is output to confirm whether the identified second user is to be used to generate recommendations (block 406). As shown in the example implementation 500 of FIG. 5, a notification 502 is output to confirm whether user preferences of a detected user are to be used to generate recommendations. This may be performed for “new” users that do not have user preferences established to begin storing the user preferences, may be used for users having existing preferences, and so on.

Responsive of the identification of the second user, a second set of user preferences that correspond to the second user along with the first set of user preference are used by the computing device to recommend content to the first and second users in which the first set of user preferences is ranked higher than the second set of user preferences in generating the recommendation (block 408). The first set of user preferences, for instance, may be given greater weight than the second set of user preferences when making the recommendations.

As previously described, the user preferences may be generated and describe preferred content consumption in a variety of ways, such as to indicate likes, dislikes, include use of filters (e.g., for age appropriate content), and so forth. Although individual user preferences were described in this example, group user preferences may also employ the ranking technique, such as to include a user preference for a group (e.g., two or more users) as well as a user preference for another individual user that is not part of the group. Further discussion of a set of user preferences for a group may be found in relation to the following figure.

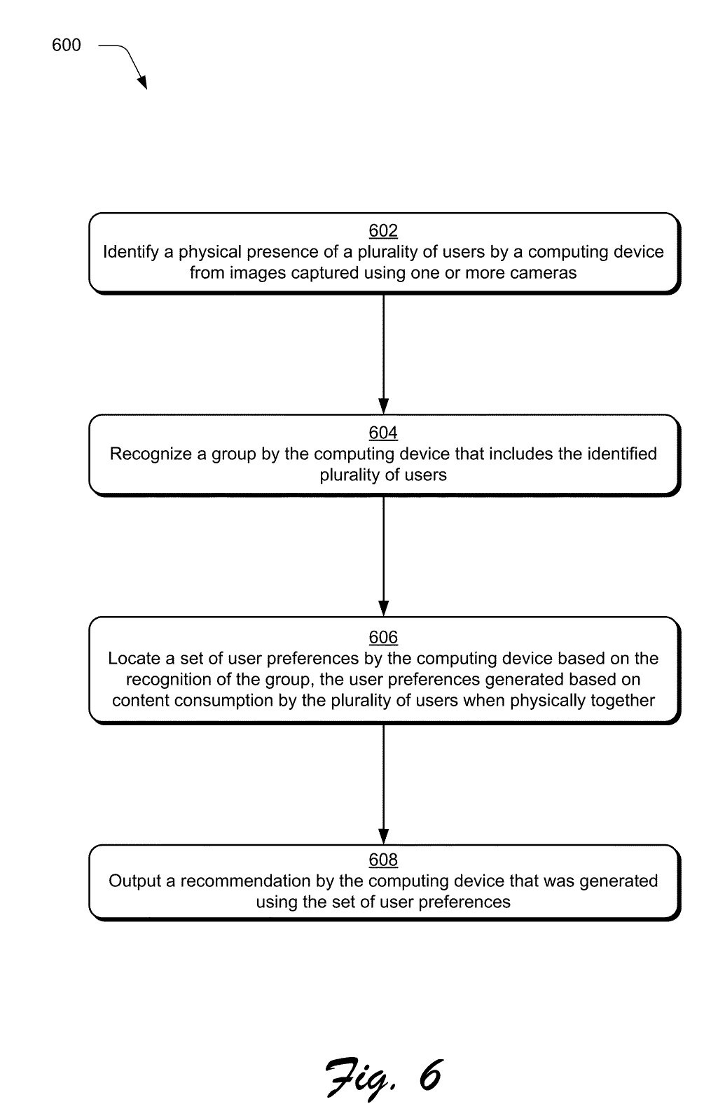

FIG. 6 depicts a procedure 600 in an example implementation in which identification of a group is used to locate user preferences for the group to make content recommendations. A physical presence of a plurality of users is identified by a computing device from images captured using one or more cameras (block 602). For example, depth-sensing cameras of the NUI input device may be leveraged by the content consumption module 114 to perform motion analysis to identify users, such as to perform feature extraction and skeletal mapping.

A group is recognized by the computing device that includes the identified plurality of users (block 604). For example, four users may be detected, three of which are identified as being members of a group. Accordingly, instead of locating sets of preferences for the individual members of the group, the preferences for the group may be located. Additionally, the content consumption module 114 may locate individual preferences for the fourth user that is not part of the group, add the fourth user to the group, create a new group, and so on.

A set of user preferences are located by the computing device based on the recognition of the group, the user preferences generated based on content consumption by the plurality of users when physically together (block 606). Continuing with the previous example, the set of user preferences for the group may be used to accurately reflect content consumption that may not be accurately described using the individual sets of preferences as previously described. A variety of other examples are also contemplated.

Example System and Device

FIG. 7 illustrates an example system generally at 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. Thus, the content consumption module 114 may be distributed through the computing device 702 and a web platform, implemented by the web platform itself, and so on.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This functionality may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
identifying a physical presence of a plurality of users by a computing device from images captured using one or more cameras;
recognizing a group by the computing device that includes the identified plurality of users;
locating a set of user preferences by the computing device based on the recognition of the group, the user preferences generated based on content consumption by the plurality of users when physically together;
analyzing available content by source, type, and quality of the content based on the set of user preferences of the group; and
populating a schedule of content recommendations based on an intersection of the set of user preferences and the available content.

2. A method as described in claim 1, wherein the located set of user preferences for the group is not based on content consumption of one or more said users when apart from the group.

3. A method as described in claim 1, wherein the located set of user preferences for the group is based solely on content consumption of the plurality of users when physically together.

4. A method as described in claim 1, wherein the set of user preferences for the group are located in local storage of the computing device.

5. A method as described in claim 1, wherein the set of user preferences for the group are located from remote storage that is accessible over a network connection by the computing device.

6. A method as described in claim 1, wherein the identifying is based on feature extraction and skeletal mapping.

7. A method as described in claim 1, wherein the identifying is based on motion analysis.

8. A method as described in claim 1, further comprising:
identifying a physical presence of a first said user by the computing device; and
locating a set of user preferences based on the identifying of the first said user, the set of user preferences generated based on content consumption of the first said user apart from the group.

9. A method as described in claim 1, wherein the set of user preferences for the group is not generated based on an intersection of user preferences for the plurality of users of the group, individually.

10. A method as described in claim 1, wherein the set of user preferences for the group includes preferences based on a time of day, a day of a week, a season, or a month of a year.

11. A method comprising:
using a first set of user preferences by a computing device to recommend content to a first user based on identification of a physical presence of the first user;
identifying an addition of physical presence of a second user by the computing device along with the physical presence of the first user; and
responsive of the identifying of the second user, using a second set of user preferences that correspond to the second user along with the first set of user preference by the computing device to recommend content to the first and second users in which the first set of user preferences is ranked higher than the second set of user preferences in generating the recommendation.

12. A method as described in claim 11, wherein the first set of user preferences is ranked higher than the second set of user preferences in generating the recommendation such that the first set of user preferences is given greater weight in making the recommendation than the second set of user preferences.

13. A method as described in claim 11, wherein the first and second users are identified through images captured by a camera of the computing device.

14. A method as described in claim 11, wherein the identification is performed using motion analysis.

15. A method as described in claim 11, further comprising:
identifying a physical presence of a plurality of users by the computing device, the plurality including the first and second user as well as an additional third user;
recognizing a group by the computing device that includes the identified plurality of users; and
locating a third set of user preferences by the computing device based on the recognition of the group, the third set of user preferences generated based on content consumption by the plurality of users when physically together such that the third set of user preferences is not generated based on the first and second set of user preferences.

16. A method as described in claim 15, wherein the set of user preferences for the group is not generated based on an intersection of user preferences for the plurality of users of the group, individually.

17. A computing device comprising:
one or more cameras;
a display device; and
one or more modules implemented at least partially in hardware, the one or more modules configured to:
receive images from the one or more cameras;
identify a group of users that are physically present from the images;
locate user preferences for the group of users, the user preferences formed solely based on content consumption by the group of users when together;
determine available content based on an intersection of the user preferences of the group and the available content by source, type, and quality of the content; and
display one or more recommendations as a schedule, on the display device, for the available content that is currently available via a broadcast.

18. A computing device as described in claim 17, wherein the located user preferences is not generated based on an intersection of user preferences for the plurality of users of the group, individually.

19. A computing device as described in claim 17, wherein the one or more modules are configured to identify the group of users using motion analysis.

20. A computing device as described in claim 17, wherein the content is television programming.
